(19) United States
(12) Patent Application Publication
(10) Pub. No.: US 2003/0090732 A1
(43) Pub. Date: May 15, 2003

(54) Electric copy board and control method thereof

(75) Inventor: Atsushi Suzuki, Numazu-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Toshiba Tec Kabushiki Kaisha, Tokyo (JP)

(21) Appl. No.: 10/040,995

(22) Filed: Nov. 9, 2001

(51) Int. Cl. H04N 1/21; H04N 1/00

(52) U.S. Cl. 358/296; 358/402

(57) ABSTRACT

A scanner is provided which reads an image written on a white board and generates image data indicative of the image. The image data generated by the scanner is transferred via a LAN or the Internet under the control of a CPU.

### BACKGROUND OF THE INVENTION

1. Field of the Invention

The present invention relates to an electric copy board with a function for reading an image written by a user on a writing board, such as a white board, and a control method for use in the electric copy board.

2. Description of the Related Art

An electric copy board with a function for printing an image written on a white board is well known.

This electric copy board enables an image written on the white board to be printed onto a paper sheet and hence easily shifted to another place, or to be stored.

However, when distributing an image written on the white board to a number of people, it is necessary to repeat the printing operation of the image several times, or to copy the paper sheet with the image on it, using another copy machine. Thus, time and effort are required.

### BRIEF SUMMARY OF THE INVENTION

It is the object of the present invention to enable an image written by a user on a writing board to be easily distributed to a number of people.

According to an aspect of the present invention, there is provided an electric copy board configured as below.

An electric copy board comprising: a writing board for a user to freely write an image on; a reader configured to read an image written on the writing board to thereby generate image data indicative of the image; an encoder configured to encode the image data generated by the reader; and a transfer section configured to transfer, via a computer network, the image data encoded by the encoder.

According to another aspect of the present invention, there is provided a control method as below.

A control method for an electric copy board equipped with a writing board on which a user freely writes an image, comprising: reading an image written on the writing board and generating image data indicative of the image; and transferring the generated image data via a computer network.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view illustrating an outward appearance of an electric copy board according to an embodiment of the invention;

FIG. 2 is a plan view illustrating an outward appearance of an operation panel;

FIG. 3 is a block diagram illustrating an essential part of an electric circuit incorporated in the electric copy board shown in FIG. 1;

FIG. 4 is a flowchart illustrating transfer control;

FIG. 5 is a flowchart illustrating a transfer process;

FIG. 6 is a flowchart illustrating retransfer control;

FIG. 7 is a flowchart illustrating print control; and

FIG. 8 is a flowchart illustrating a process to be executed when accessed.

### DETAILED DESCRIPTION OF THE INVENTION

An embodiment of the invention will be described with reference to the accompanying drawings.

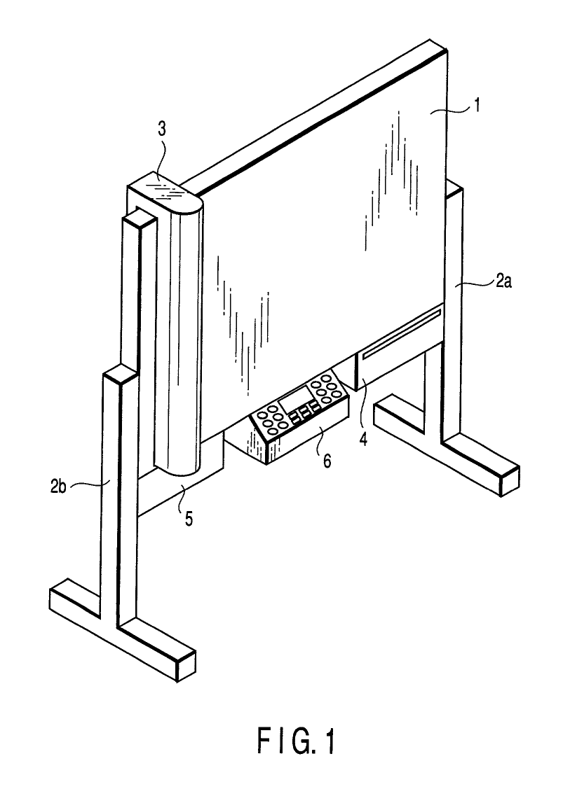

FIG. 1 is a perspective view illustrating an outward appearance of an electric copy board according to the embodiment of the invention.

As shown in FIG. 1, the electric copy board of the embodiment comprises a white board 1, leg sections 2a and 2b, a scanner 3, a printer 4, a communication unit 5 and an operation panel 6.

The white board 1 is supported by the leg sections 2a and 2b. On the white board 1, the user can write any image, using a marker.

The scanner 3 reads an image written on the white board 1 while traversing the white board 1. The scanner 3 generates image data indicative of the read image.

The printer 4 prints out an image based on image data generated by the scanner 3.

The communication unit 5 contains a circuit for executing a communication process for the transfer of image data generated by the scanner 3.

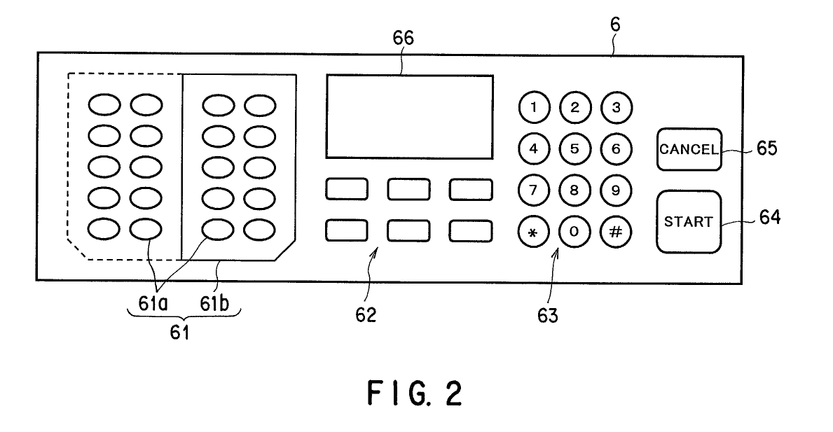

FIG. 2 is a plan view illustrating an outward appearance of the operation panel 6.

As shown in FIG. 2, the operation panel 6 includes a multifunction-key section 61, a function-key section 62, a ten-key section 63, a start key 64, a cancel key 65 and a display 66.

The multifunction-key section 61 includes a plurality of keys 61a and a plate 61b. The plate 61b is movable and can assume any one of positions indicated by the solid line and the broken line in FIG. 2. Depending upon the position of the plate 61a, the plurality of keys 61a function as one-touch keys or character-input keys.

The function-key section 62 is used to designate jobs such as the execution of printing and the execution of transfer, etc.

The ten-key section 63 is used to input numerals.

The start key 64 is used to designate the execution of processing.

The cancel key 65 is used to designate the canceling of processing.

The display is formed of, for example, an LCD, and displays various information to be notified to the user.

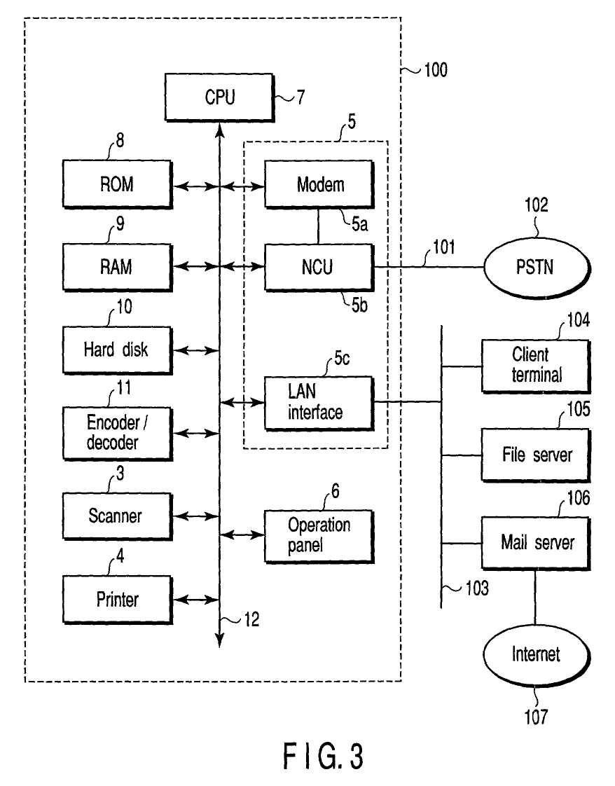

FIG. 3 is a block diagram illustrating an essential part of an electric circuit incorporated in the electric copy board shown in FIG. 1. In FIG. 3, the same elements as in FIG. 1 are denoted by corresponding reference numerals, and no detailed explanation will be given thereof.

In FIG. 3, the electric copy board according to the embodiment is denoted by reference numeral 100. The electric copy board 100 comprises the scanner 3, the printer 4, the communication unit 5, the operation panel 6, a CPU 7, a ROM 8, a RAM 9, a hard disk 10 and an encoder/decoder 11, as shown in FIG. 2. These sections are connected to each other via a bus 12.

The communication unit 5 also includes a modem 5a, a NCU 5b and a LAN interface 5c.

The modem 5a modulates image data to thereby generate a facsimile transmission signal, or modulates a command supplied from the CPU 7, to thereby generate a command transmission signal. The modem 5a transmits these transmission signals to a PSTN subscriber line 101 via the NCU 5b. Further, the modem 5a receives, via the NCU 5b, a facsimile transmission signal or a command transmission signal supplied via the PSTN subscriber line 101. The modem 5a demodulates the facsimile transmission signal to thereby reproduce image data, or demodulates the command transmission signal to thereby reproduce a command.

A PSTN 102 is connected to the NCU 5b via the PSTN subscriber line 101. The NCU 5b monitors the state of the PSTN subscriber line 101 or transmits a signal to the PSTN 102. Further, the NCU 5b executes equalization on the facsimile transmission signal to be transmitted to the PSTN subscriber line 101, and sets the output level of the facsimile transmission signal.

The LAN interface 5c is connected to a LAN 103. The LAN interface 5c transmits data between itself and another terminal connected to the LAN 103. To the LAN 103, a client terminal 104, a file server 105 and a mail server 106, etc. are connected, for example. The mail server 106 is further connected to the Internet 107.

The CPU 7 executes software processing based on an operation program stored in the ROM 8, thereby controlling each section of the electric copy board to realize its operations.

The ROM 8 stores the operation program, and the like.

The RAM 9 is used as, for example, a work area for storing various types of information necessary for the CPU 7 to execute various processes.

The hard disk 10 stores various types of setting information and image data.

The encoder/decoder 11 executes an encoding process on image data for compressing its redundancy. The encoder/decoder 11 decodes encoded image data having its redundancy compressed. JBIG (Joint Bi-level Image experts Group), MMR (Modified Modified READ), or other known coding methods can be selectively employed as a coding method by the encoder/decoder 11.

The CPU 7 functions as a transfer section, as well as, as a known, general control section in the electric copy board, when it executes software processing based on the operation program stored in the ROM 8. The transfer section transfers image data via the PSTN 102 or LAN 103.

The operation of the electric copy board 100 constructed as above will be described.

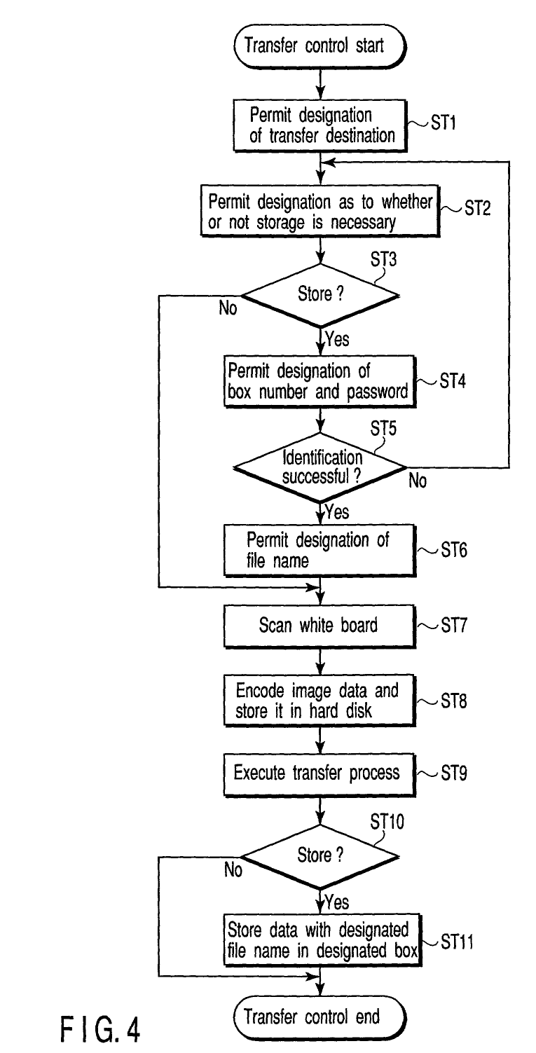

When the transfer of an image written on the white board 1 has been designated by a predetermined key operation of the operation panel 6, the CPU 7 executes transfer control as illustrated in FIG. 4.

In the transfer control, the CPU 7 first permits a destination of transfer to be designated (step ST1). The transfer destination may be designated by directly inputting a telephone number or an address, using the multifunction-key section 61 or the ten-key section 63, or by selecting a pre-registered telephone number or address as a result of pushing the multifunction-key section 61 or designating an abbreviated telephone number. Furthermore, either a single transfer destination or a plurality of transfer destinations may be designated. In the embodiment, a group of transfer destinations can be registered for each key of the multifunction-key section 61, which enables the user to easily designate a plurality of transfer destinations. Transfer destinations are registered by a dedicated process executed by the CPU 7, and registration information is stored in the hard disk 10.

Subsequently, the CPU 7 permits designation as to whether or not image data needs to be stored (step ST2), and determines whether or not the storage of data has been designated (step ST3). If the CPU 7 determines that the storage of image data has been designated, it permits the designation of a box number assigned to a file box for storing the image data, and of a password (step ST4).

The file box is preset by the CPU 7 in the hard disk 10 in response to an instruction issued by the user. Upon receiving a request to create a file box, the CPU 7 sets a new file box in the hard disk 10, and determines a box number that differs from the other box numbers assigned to the other file boxes. In relation to this box number, the password designated by the user is managed.

The CPU 7 executes identification by determining whether or not the designated box number exists, and whether or not the relationship between the box number and the password is correct, thereby determining whether or not the identification has been successful (step ST5). If the identification has been unsuccessful, it repeats the processes at the step ST2 et seq. On the other hand, if the identification has been successful at the step ST5, the CPU 7 permits a file name for image data to be designated (step ST6).

After permitting the designation of the file name at the step ST6, or after determining at the step ST3 that the storage of image data is not designated, the CPU 7 causes the scanner 3 to scan the white board 1 (step ST8). As a result, the scanner 3 reads an image written on the white board 1, and generates image data indicative of the image. The CPU 7 stores, in the RAM 9, the image data generated by the scanner 3, causes the encoder/decoder 11 to encode the image data, and stores the encoded image data in the hard disk 10 (step ST8) . If JBIG, for example, is used as a coding method to store image data in the hard disk 10, the storage area of the hard disk 10 can be used effectively.

Subsequently, the CPU 7 executes a transfer process to transfer the image data stored in the hard disk 10 (step ST9).

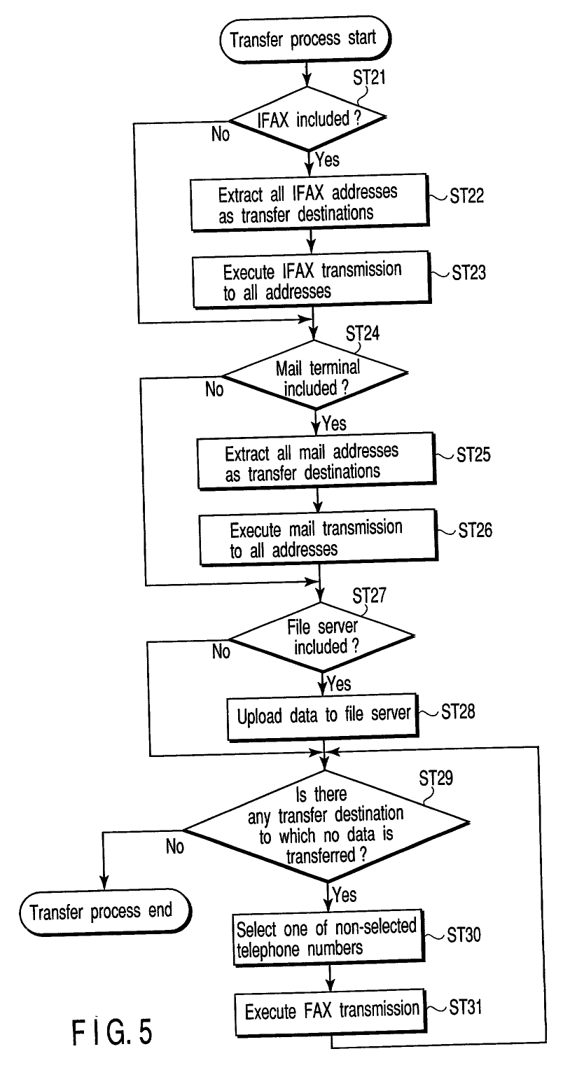

FIG. 5 is a flowchart illustrating the transfer process.

As shown in FIG. 5, at the start of the transfer process, the CPU 7 determines whether or not designated transfer destinations include any Internet facsimile terminal (IFAX) (step ST21). If the CPU determines that Internet facsimile terminals are included, it extracts addresses assigned to all Internet facsimile terminals, from the designated transfer destinations (step ST22). After that, the CPU 7 creates E-mails based on the Internet facsimile standards, which are to be sent to all the extracted addresses, thereby transmitting them to the LAN 103 via the LAN interface 5c (step ST23). As a result, image data is transferred to the designated Internet facsimile terminals via Internet facsimile transmission.

When the transfer of the image data via Internet facsimile has finished, or if the CPU 7 determines at the step ST21 that no Internet facsimile terminal is included in the designated transfer destinations, it determines whether or not the designated transfer destinations include any mail terminal (step ST24). If the CPU 7 determines that mail terminals are included, it extracts addresses assigned to all the mail terminals, from the designated transfer destinations (step ST25). After that, the CPU 7 creates E-mails with image data in a predetermined file format, which are to be sent to all the extracted addresses, thereby transmitting them to the LAN 103 via the LAN interface 5c (step ST26). As a result, image data is transferred to the designated mail terminals via E-mail transmission. The mail terminals indicate the client terminal 104 with an E-mail sending/receiving function, and terminals with an E-mail sending/receiving function connected to the Internet 107, etc.

When the transfer of image data via E-mail transmission has finished, or if the CPU 7 determines at the step ST26 that no mail terminal is included in the designated transfer destinations, it determines whether or not the designated transfer destinations include a file server 105 (step ST27). If the CPU 7 determines that a file server 105 is included, it uploads image data in a predetermined file format to the file server 105 (step ST28). Thus, image data is uploaded to the designated file server 105.

When the uploading of image data has finished, or if the CPU 7 determines at the step ST27 that no file server 105 is included in the designated transfer destinations, it determines whether or not the designated transfer destinations include a transfer designation, to which image data has not yet been transferred by the processes executed so far (step ST29). In the embodiment, such a transfer destination is a standard facsimile terminal, which is designated by a telephone number. Therefore, if such a transfer destination is determined to exist, the CPU 7 selects one of the non-selected telephone numbers (step ST30), thereby executing facsimile transmission to the selected telephone number destination (step ST31). This facsimile transmission is executed via the PSTN 102 on the basis of T. 30 of ITU-TS (International Telecommunication Union-Telecommunication Sectors).

After that, the CPU 7 repeats the processes at the steps ST29-ST31 until it determines at the step ST29 that there are no more transfer destinations to which image data is to be transferred. If the CPU 7 determines at the step ST29 that there are no more transfer destinations to which image data is to be transferred, it finishes the transfer process.

After finishing the transfer process at the step ST9, the CPU 7 determines whether or not the storage of image data is designated (step ST10 in FIG. 4). If the CPU 7 determines that the storage of image data is designated, it stores, in a file box designated at the step ST4, image data with a file name designated at the step ST6 (step ST11). This is the termination of the transfer control by the CPU 7. If the CPU 7 determines at the step ST10 that the storage of image data is not designated, it finishes the transfer control without executing the process at the step ST11.

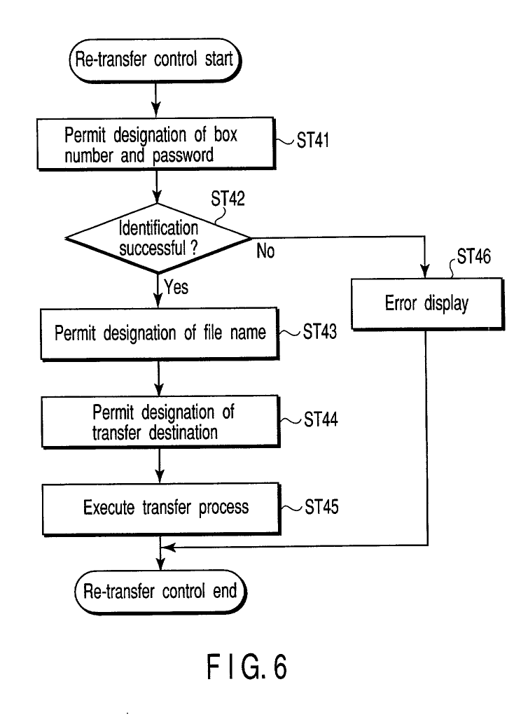

If the transfer of image data stored in the hard disk 10 is designated by a predetermined key operation of the operation panel 6, the CPU 7 executes re-transfer control as illustrated in FIG. 6.

In the re-transfer control, the CPU 7 at first permits the designation of a box number assigned to a file box that contains to-be-transferred image data, and of a password (step ST41). The CPU 7 executes identification by determining whether or not the designated box number exists, and whether or not the relationship between the box number and the password is correct, thereby determining whether or not the identification has been successful (step ST42). If the identification has been successful, the CPU 7 permits a file name for to-be-transferred image data to be designated (step ST43). Further, the CPU 44 permits a transfer destination to be designated (step ST44). The designation of the transfer destination is executed in the same manner as at the aforementioned step ST1.

Subsequently, the CPU 7 executes the aforementioned transfer process on the designated image data stored in the hard disk 10 (step ST45). After finishing the transfer process, the CPU 7 also finishes the re-transfer control.

If the CPU 7 determines at the step ST42 that the identification has been unsuccessful, it causes the display 66 to execute a predetermined error display (step ST46), and finishes the re-transfer control without executing the processes at the steps ST43-ST45. The error display indicates display of, for example, a message that the box number and/or the password is erroneous and hence transfer cannot be executed.

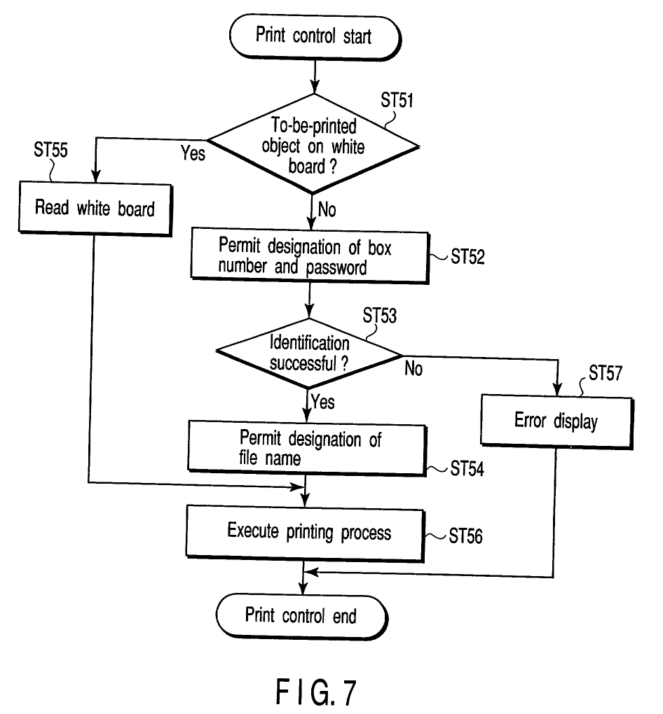

If printing is designated by a predetermined key operation of the operation panel 6, the CPU 7 executes print control as illustrated in FIG. 7.

In the print control, the CPU 7 at first determines whether or not a to-be-printed object is an image written on the white board 1 (step ST51). If the CPU 7 determines that the to-be-printed object is not an image written on the white board 1, it permits the designation of a box number assigned to a file box that contains to-be-printed image data, and the designation of a password (step ST52). The CPU 7 executes identification by determining whether or not the designated box number exists, and whether or not the relationship between the box number and the password is correct, thereby determining whether or not the identification has been successful (step ST53). If the identification has been successful, the CPU 7 permits a file name for to-be-printed image data to be designated (step ST54).

On the other hand, if the CPU 7 determines that the to-be-printed object is an image written on the white board 1, it causes the scanner 3 to scan the white board 1 (step ST55).

After the steps ST54 or ST55, the CPU 7 executes a printing process for enabling the printer 4 to execute printing (step ST56). The printing process is executed on the basis of image data with the file name designated at the step ST54, or image data generated by the scanner 3. After printing an image, the CPU 7 finishes the print control.

If the CPU 7 determines at the step ST53 that the identification has been unsuccessful, it causes the display 66 to execute a predetermined error display (step ST57), and finishes the print control without executing the steps ST54 and ST56. The error display indicates display of, for example, a message that the box number and/or the password is erroneous and hence printing cannot be executed.

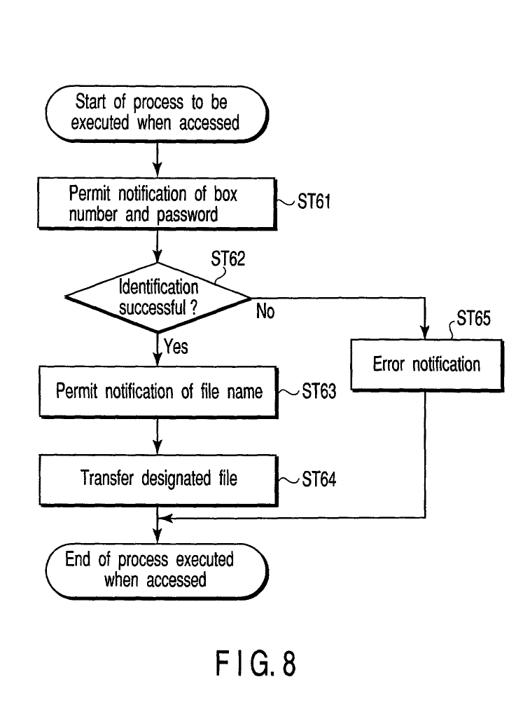

When the CPU 7 is accessed via the LAN 103, it executes a process, as illustrated in FIG. 8, to be executed when it is accessed.

In the process executed when accessed, the CPU 7 at first permits an accessing terminal to notify a box number for the file box that contains to-be-transferred image data, and a password (step ST61). The CPU 7 executes identification by determining whether or not the designated box number exists, and whether or not the relationship between the box number and the password is correct, thereby determining whether or not the identification has been successful (step ST62). If the identification has been successful, the CPU 7 permits the accessing terminal to notify a file name for the to-be-transferred image data (step ST63). After that, the CPU 7 transfers, to the accessing terminal, the designated image data file stored in the hard disk 10 (step ST64). After finishing the transfer process, the CPU 7 finishes the access procedure.

If, on the other hand, the CPU 7 determines at the step ST62 that the identification had been unsuccessful, it executes error notification to the accessing terminal (step ST65), and finishes the access procedure without executing the steps ST63 and ST64. The error notification is executed by, for example, transmitting a command indicating that the box number and/or the password is erroneous and hence transfer cannot be executed.

As described above, in the embodiment, image data indicative of an image written on the white board 1 can be transferred to another Internet facsimile terminal or mail terminal via the LAN 103 or the Internet 107. This enables conference minutes, for example, written on the white board 1 to be easily distributed to the relevant people. Further, in the embodiment, data can also be transmitted to a facsimile terminal via the PSTN 102, which means that data can be transferred to a destination that has no Internet facsimile terminal or mail terminal.

Moreover, in the embodiment, image data generated by reading an image written on the white board 1 can be stored in the hard disk 10. The stored image data can be transferred later to various types of other terminals, or can be printed later. Accordingly, even after an image written on the white board 1 is erased, it can be distributed again. When storing image data in the hard disk 10, the limited capacity of the hard disk 10 can be effectively used, since the image data is compressed. Further, since image data is managed in units of file boxes and a password is assigned to each file box to make it impossible to fetch image data from each file box unless a correct password is designated, image data stored therein can be prevented from being illegally read by a third party.

Furthermore, in the embodiment, image data stored in the hard disk 10 is transferred in response to a request issued via the LAN 103. Also, image data is uploaded to the file server 105, making it possible to fetch the image data from the file server 105. Accordingly, the user does not have to move to the electric copy board 100 and operate it to fetch image data, but can obtain it from a remote terminal such as the client terminal 104.

In addition, the embodiment employs the white board 1. However, another member, such as a black board, can be used in place of the white board 1.

In the embodiment, the scanner 3 is moved to read an image written on the white board 1. However, the white board may be formed of a belt member and a mechanism for rotating the belt member, so that an image written on the belt member may be read by moving the belt member instead of the scanner.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electric copy board comprising:
a writing board for a user to freely write an image on;
a reader configured to read an image written on the writing board to thereby generate image data indicative of the image;
an encoder configured to encode the image data generated by the reader; and
a transfer section configured to transfer, via a computer network, the image data encoded by the encoder.

2. The electric copy board according to claim 1, wherein the transfer section transfers the image data as a file attached to an E-mail.

3. The electric copy board according to claim 1, wherein the transfer section transfers the image data in accordance with Internet facsimile standards.

4. The electric copy board according to claim 1, wherein the transfer section transfers the image data, in response to a request issued via the computer network, to a destination which issued the request.

5. The electric copy board according to claim 1, wherein the transfer section uploads the image data to a server which executes data distribution via the computer network.

6. The electric copy board according to claim 1, wherein the transfer section transfers the image data via another network, as well as the computer network.

7. The electric copy board according to claim 1, further comprising a storage section configured to store the image data.

8. The electric copy board according to claim 7, wherein the transfer section transfers the image data stored in the storage section.

9. The electric copy board according to claim 1, wherein the encoder encodes the image data by JBIG (Joint Bi-level Image experts Group).

10. The electric copy board according to claim 1, wherein the encoder encodes the image data by MMR (Modified Modified READ).

11. A control method for an electric copy board equipped with a writing board on which a user freely writes an image, comprising:
reading an image written on the writing board and generating image data indicative of the image; and
transferring the generated image data via a computer network.
